(19) United States
(12) Patent Application Publication
(10) Pub. No.: US 2011/0293365 A1
(43) Pub. Date: Dec. 1, 2011

(54) CEMENT PLANT REFRACTORY ANCHOR

(75) Inventors: Nick Lebaut, Bulli (AU); Nan Xu, Mulgrave (AU)

(73) Assignee: VESUVIUS CRUCIBLE COMPANY, Wilmington, DE (US)

(21) Appl. No.: 13/139,339

(22) PCT Filed: Dec. 11, 2009
(86) PCT No.: PCT/AU09/01611

§ 371 Date: Aug. 5, 2011

(30) Foreign Application Priority Data
Dec. 12, 2008 (AU) 2008906407

(51) Int. Cl. F27D 1/14; C23C 10/56; C23C 10/50; F27D 1/10

(52) U.S. Cl. 403/404; 148/283

(57) ABSTRACT

A cement plant refractory anchor (10) comprising a body formed of stainless steel, wherein external surfaces of said body have a surface diffusion coating of an iron aluminide phase formed by a high temperature pack cementation process.

### FIELD OF THE INVENTION

The present invention relates to a cement plant refractory anchor for use in cement plant pre-heater towers. However, it will be appreciated by those skilled in the art that the invention is not limited to pre-heater towers, and it may be applied to heat exchangers, expansion bellows, burners, tube hangers and other high temperature components used in the cement industry.

### BACKGROUND OF THE INVENTION

Portland cement is the basic ingredient in both concrete and mortar. The production of Portland cement involves combining limestone with small quantities of other materials such as clay, and heating the mixture in a kiln. The resulting product sinters into lumps or nodules, and is commonly called ‘clinker’. The clinker is subsequently ground with gypsum into a powder to make ‘ordinary Portland cement’, which is the most commonly used type of cement.

In a cement plant, a preheater tower is used in the clinker production process. The preheater tower supports a series of vertical chamber cyclones through which the raw materials such as limestone and clay pass on route to the kiln. Other additives in the clinker include chlorides, sulphur, alkalides, carbon monoxide, nitrogen oxides, and sulphur dioxide. The raw material is preheated prior to entry into the kiln, and hot gasses are circulated using risers and ducts. The temperature range within the risers and ducts is typically between 850° C. and 950° C.

The internal walls of the cyclones and risers are lined with refractory material, and the refractory material is mechanically supported with refractory anchors. The refractory anchors are typically stainless steel anchors which are welded to the outer steel shell of the cyclones and risers. The refractory anchors are welded to the steel shell, and the refractory material is subsequently applied to the shell in two layers. An insulation layer is located adjacent to the shell, and a second hot face layer is located furthest from the shell. The refractory anchors extend through both the insulating layer and the hot face layer. Because the refractory material does not bond adequately to the steel shell itself, the anchors are arranged in a matrix which serves to mechanically secure the refractory lining to the shell.

Refractory anchors are typically manufactured from 253MA stainless steel. 253MA is an austenitic chromium-nickel steel containing rare earth metals. A typical composition of 253MA may contain chromium 20-22%, nickel 10-12 percent, silicon 1.4-2% small amounts of carbon, manganese, nitrogen, and cerium, and the remainder iron.

253MA stainless steel has high strength at elevated temperatures and as such is often used for structural applications at temperatures up to about 900° C. 253MA provides excellent resistance to air at temperatures up to 1150° C., because at high temperatures 253MA stainless steel quickly forms a thin, elastic oxide, which acts as a sacrificial lining which protect the surface. In addition, 253MA stainless steel has a good resistance to sigma phase embrittlement. All of the above make 253MA stainless steel a good option for refractory anchors in cement plants.

Refractory anchor failure is a well recognised problem in cement plants. When refractory anchors fail, portions of the refractory material may separate from the steel shell resulting in cyclone blockage. In addition, during maintenance shutdowns, any refractory anchor failure endangers the lives of workers, and is hence of significant safety concern.

Alternative fuels are also used in cement plant in order to reduce CO2 emission and maximise the recovery of energy. Alternative fuels include but are not limited to: tyres, rubber paper waste, waste oils, waste wood, paper sludge, sewage sludge, plastic and spent solvent. The combustion of these alternative fuels in a cement plant preheater tower and kiln release high concentrations of, but not limited to, chlorides, sulphur, phosphates, vanadium and heavy metals.

The applicant has found that high temperature chlorination attack is the primary cause for refractory anchor failure in cement plants. The porosity of the refractory material enables the ingression of chlorine deep into the refractory lining where the refractory anchors are located. The chlorine diffuses through pores in the oxide scale on the surface of the anchors, forming volatile metal chlorides. Over time, the chlorine induced corrosion of 253MA stainless steel results in significant metal wastage, ultimately failure of the refractory anchors and therefore failure of the refractory lining.

In addition, the stresses caused by the growth of metal oxides may promote cracking in the hot face refractory lining. Such cracking in the refractory provides a flow path for the corrosive chlorine to follow to the anchors.

In practice, the lifespan of refractory anchors in cement plants is typically around two years. At the end of this period the refractory material must be removed and reapplied, during a costly shut down operation. The closure of the cement plant for repair and maintenance purposes incurs significant costs to the plant operators.

In order to prolong the life of the refractory anchors, it is known to protect the surface of refractory anchors with a zircon based paint. Whilst the zircon paint itself is resistant to harmful acids and chemicals that attack the surfaces of the refractory anchors, the zircon paint does not sufficiently protect the edges and corners of the refractory anchors. In addition, at the operating temperatures encountered within the cement plant, the 253MA stainless steel experiences levels of thermal expansion different to the zircon coating. Accordingly, over time the zircon paint is known to separate from the anchors, leaving the refractory anchors susceptible to chlorination attack.

### OBJECT OF THE INVENTION

It is an object of the present invention to substantially overcome or at least ameliorate one or more of the above disadvantages, or to provide a useful alternative to existing refractory anchors

### SUMMARY OF THE INVENTION

In a first aspect, the present invention provides a cement plant refractory anchor comprising: a body formed of stainless steel, wherein external surfaces of said body have a surface diffusion coating of an iron aluminide phase formed by a high temperature pack cementation process.

In a second aspect, the present invention provides a cement plant refractory anchor comprising:

a body formed of stainless steel, wherein external surfaces of said body have a surface diffusion coating of iron aluminide and nickel aluminide phases formed by a high temperature co-deposition pack cementation process.

The stainless steel is preferably 253MA grade.

The surface diffusion coating also preferably includes chromium in the iron aluminide and nickel aluminide phases formed by a co-deposition high temperature pack cementation process.

The anchor preferably has a stem having a proximal end securable to a surface within the cement plant, and a distal end which is split into two arms, defining a generally Y-shaped profile.

In a third aspect, the present invention provides a method of forming a protective layer on the external surfaces of a stainless steel cement plant refractory anchor with high temperature pack cementation, said protective layer providing protection against high temperature chlorination attack, said method including the steps of:

placing a mixture in a retort, said mixture including:
fused alumina (Al2O3) filler;
aluminium, or nickel-aluminium or chromium-aluminium master alloys; and
a halide salt activator;

placing said refractory anchor within said mixture; and

increasing the temperature within the retort to 950-1100 degC to cause the halide salt to react with the aluminium or alloy of aluminium forming a gaseous metallic halide which is transported to the external surfaces of the refractory anchor by gaseous diffusion, wherein the metallic halide reacts with the surface of the stainless steel, depositing the aluminium or aluminium—chromium on the surface of the refractory anchors as a diffusion coating.

The diffusion coating is preferably iron aluminide or iron aluminide and nickel aluminide.

The halide salt activator is preferably sodium fluoride.

The halide salt activator is preferably ammonium chloride and sodium chloride.

The master alloy is preferably aluminium chromium (Al—Cr) and the method forms a co-deposited diffusion coating of iron aluminide and nickel aluminide containing chromium.

The step of increasing the temperature within the retort preferably includes pre-heating the retort to about 200° C. for a period of about 3 hours, and increasing the temperature to about 1100° C. for a period of about 8 hours.

The step of increasing the temperature within the retort preferably includes pre-heating the retort to about 200° C. for a period of about 3 hours, and increasing the temperature to about 1100° C. for a period of about 16 hours.

The method preferably includes the step of circulating an inert gas around the exterior of the retort.

The method further preferably includes the step of treating the refractory anchor with a peroxide to increase the aluminium oxide in the protective layer.

### BRIEF DESCRIPTION OF THE DRAWINGS

A preferred embodiment of the invention will now be described by way of specific example with reference to the accompanying drawings, in which:

FIG. 1 shows a 253MA stainless steel refractory anchor secured to a steel shell;

FIG. 2 is a temperature time diagram showing the high temperature pack cementation process for forming a diffusion coating on the refractory anchor of FIG. 1; and

FIG. 3 is a schematic diagram showing the retorts used in the high temperature pack cementation process of FIG. 2.

### DETAILED DESCRIPTION OF THE PREFERRED EMBODIMENTS

A first embodiment of a refractory anchor 10 made of 253MA stainless steel, or a similar grade of stainless steel is treated with a “pack cementation” or pack diffusion process by which a protective coating is applied to the outer substrate layer of the refractory anchor 10.

Prior to pack cementation, the refractory anchor may be grit blasted to prepare the surface for diffusion coating.

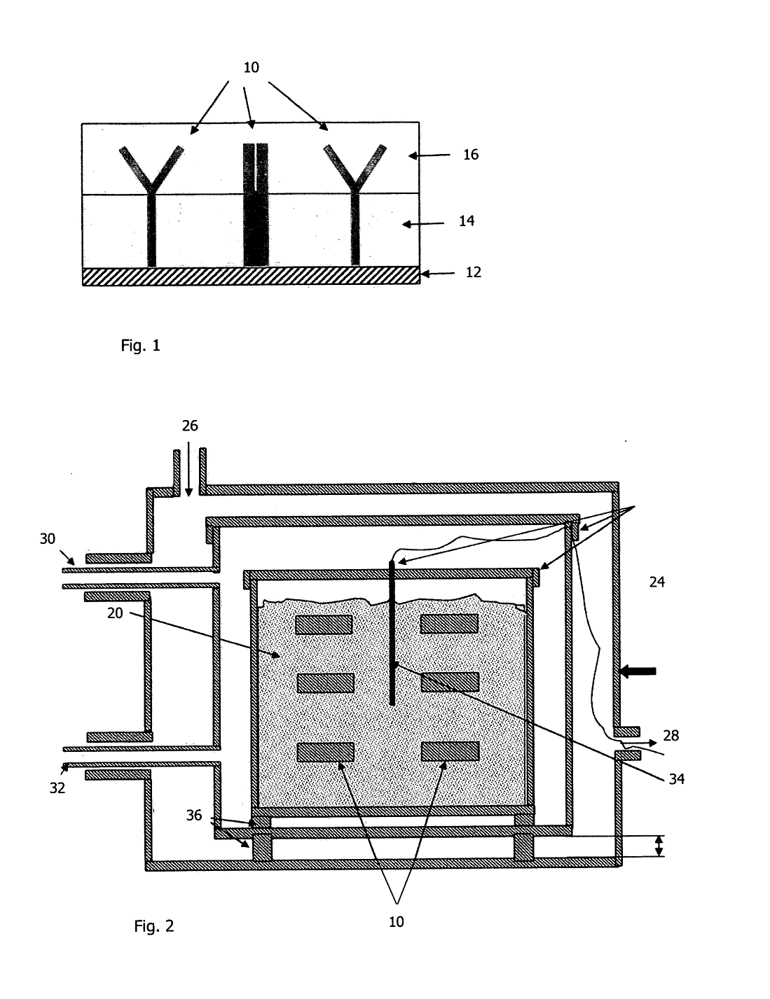

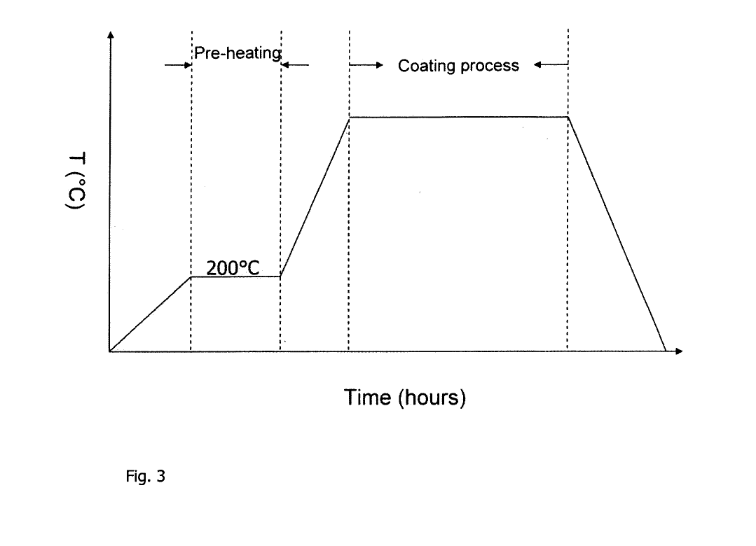

The coating material diffuses in the surface of the substrate, becoming part of the grain structure of the outer substrate layer, and thereby forms a diffusion coating on the refractory anchors 10. As shown in FIG. 1, the anchor 10 has a stem having a proximal end securable to a surface within the cement plant, and a distal end which is split into two arms, defining a generally Y shaped a profile.

As shown in FIG. 1, the refractory anchors are welded to the steel shell 12 of the cyclones and risers. The anchors 10 extend into the refractory insulation layer 14 adjacent to the shell, and the hot face layer 16 located furthest from the shell 12.

As depicted in FIG. 2, a packing material mixture 20 is placed within a retort 22, or another such sealed vessel, and refractory anchors 10 to be treated are placed in the retort 22, interspaced between the packing material 20. The retort 22 is generally filled with the packing material 20, sealed and then located within a furnace 24.

The packing material 20 of the first embodiment contains a number of ingredients, which will now be discussed in detail.

A master alloy is included in the packing material in powdered form. The master alloy contains the metal, or metal alloy that will ultimately be deposited onto the surface of the refractory anchors 10, as an inter-diffused layer. The master alloy may be aluminium (Al), chromium-aluminium (Cr—Al), silicon (Si), nickel-aluminium (Ni—Al), or another suitable alloy.

According to the first embodiment, the master alloy used to diffusion coat the refractory anchors 10 is either Aluminium or nickel-aluminium or chromium-aluminium.

The packing material 20 also includes an inert filler. The inert filler is fused alumina Al₂O₃, which provides physical support for the refractory anchors 10 within the retort 22. In addition, the inert filler is sufficiently porous to provide gas flow paths through the cementation powder. This permits gaseous metallic halides to travel to the substrate surfaces of the refractory anchors 10. The inert filler also serves to prevent sintering of the metallic master alloy to itself.

The packing material 20 also requires an activator in the form of halide salts sodium fluoride for the aluminising pack or ammonium chloride, sodium chloride for the co-deposition pack As the temperature in the retort 22 is increased, the halide salts react with the aluminium, forming gaseous metallic halides AlXn. The gaseous metallic halides are transported by gaseous diffusion to the surface of the refractory anchors 10. The metallic halides then react with the surface of the 253MA stainless steel anchors 10, depositing the master alloy on the surface of the refractory anchors 10 typically as a diffusion coating of iron aluminide.

At the substrate surface, the deposition process causes the gas to break down, thereby depositing the iron aluminide or iron aluminide and nickel aluminide phases and releasing the halogen activator back into the pack. The halide activator is then free to react with the aluminium powder, again reforming the metallic halide AlXn. Accordingly, the pack cementation process continues until there is no aluminium left in the pack, or alternatively when the heat is decreased, terminating the chemical reaction.

As shown in FIG. 2, an inert gas such as Argoplas 5 consisting of 95% Argon (Ar), 5% Hydrogen (H₂) which is non-combustible is circulated around the retort 22. The inert gas may flow in two or more flow paths, and as shown in FIG. 2, a first flow of inert gas enters through the conduit 26 and exits through conduit 28. In addition, a second flow of the inert gas enters through conduit 30 and exits through conduit 32. The inert gas is free to circulate in the cavity around the retort, and ceramic spacers 36 are used to elevate the retort 22, providing gas flow paths beneath the retort 22. The inert gas establishes a reducing condition, and purges any oxygen/air from the system.

A thermocouple 34 is provided with an alumina sheath to monitor the internal temperature within the retort 22, among the cementation powder.

The process for surface treating the refractory anchors 10 involves preheating the retort to about 200° C. to remove the moisture within the cementation powder, and to purge out the remaining oxygen from the system. After a period of approximately 3 hours, the temperature is increased to 950-1100 deg C., and maintained at the increased temperature for 8 to 16 hours. The temperature is then lowered, and the refractory anchors 10 are removed from the furnace.

A second embodiment of a refractory anchor made of 253MA stainless is also disclosed. Like reference numerals will be used. In the second embodiment, the refractory anchors 10 are treated by pack cementation in a co-deposition process of chromium aluminium Cr—Al. The process is similar to the process described above for the first embodiment. However, the master alloy contains a mix of aluminium and chromium. This may be an alloy, or a mixture of aluminium and chromium particles. The co-deposition process generates a diffusion coating of chromium and aluminium, which has a greater resistance to cracking than a diffusion coating of iron aluminide alone. In the second embodiment, the halide salt used is Ammonium Chloride NH₄Cl and Sodium Chloride.

The same inert filler of fused alumina Al₂O₃ is used.

The diffusion coating formed by the pack cementation process is in the range of 150 to 200 to microns in thickness.

When the diffusion coating process is complete, the coating includes an outer layer of iron aluminides and an inner layer due to inward diffusion of aluminium into the 253MA stainless steel substrate.

After the pack cementation process is complete, the refractory anchor 10 are treated with a peroxide to increase the aluminium oxide in the diffusion coating.

An advantage of the process of the first and second embodiments is that the coating formed is uniform and very compact, diffused in the surface of the substrate and resistant to high temperature chlorine induced corrosion.

A further advantage is that the aluminium oxide Al₂O₃ diffusion layer that forms on the iron aluminide or iron aluminide and nickel aluminide phases has a higher thermodynamic stability than other elements. Aluminium oxide acts as a protective barrier from chlorine induced corrosion attack.

A still further advantage is that the high temperature pack cementation process is not restricted by the complex shape of the refractory anchors 10, despite the anchors having a generally Y shaped profile. The diffusion coating is able to penetrate corners and bends of the anchor 10.

Although the invention has been described with reference to specific examples, it will be appreciated by those skilled in the art that the invention may be embodied in many other forms.

1. A cement plant refractory anchor comprising:
a body formed of stainless steel, wherein external surfaces of said body have a surface diffusion coating of an iron aluminide phase formed by a high temperature pack cementation process.

2. A cement plant refractory anchor comprising:
a body formed of stainless steel, wherein external surfaces of said body have a surface diffusion coating of iron aluminide and nickel aluminide phases formed by a high temperature co-deposition pack cementation process.

3. The refractory anchor of claim 1, wherein the stainless steel is 253MA grade.

4. The refractory anchor of claim 2, wherein the surface diffusion coating also includes chromium in the iron aluminide and nickel aluminide phases formed by a code position high temperature pack cementation process.

5. The refractory anchor of claim 1, wherein the anchor has a stem having a proximal end securable to a surface within the cement plant, and a distal end which is split into two arms, defining a generally Y-shaped profile.

6. A method of forming a protective layer on the external surfaces of a stainless steel cement plant refractory anchor with high temperature pack cementation, said protective layer providing protection against high temperature chlorination attack, said method including the steps of:
placing a mixture in a retort, said mixture including:
fused alumina (Al₂O₃) filler;
aluminium, or nickel-aluminium or chromium-aluminium master alloys; and
a halide salt activator;
placing said refractory anchor within said mixture; and
increasing the temperature within the retort to 950-1100 deg C. to cause the halide salt to react with the aluminium or alloy of aluminium forming a gaseous metallic halide which is transported to the external surfaces of the refractory anchor by gaseous diffusion, wherein the metallic halide reacts with the surface of the stainless steel, depositing the aluminium or aluminium-chromium on the surface of the refractory anchors as a diffusioncoating.

7. The method of claim 6, wherein the stainless steel is 253MA grade.

8. The method of claim 6, wherein the diffusion coating is iron aluminide or iron aluminide and nickel aluminide.

9. The method of claim 6, wherein said halide salt activator is sodium fluoride.

10. The method of claim 6, wherein said halide salt activator is ammonium chloride and sodium chloride.

11. The method of claim 9 wherein the master alloy is aluminium chromium (AI—Cr) and the method forms a co-deposited diffusion coating of iron aluminide and nickel aluminide containing chromium.

12. The method of claim 6, wherein the step of increasing the temperature within the retort includes pre-heating the retort to about 200° C. for a period of about 3 hours, and increasing the temperature to about 1100° C. for a period of about 8 hours.

13. The method of claim 6, wherein the step of increasing the temperature within the retort includes pre-heating the retort to about 200° C. for a period of about 3 hours, and increasing the temperature to about 1100° C. for a period of about 16 hours.

14. The method of claim 6, including the step of circulating an inert gas around the exterior of the retort.

15. The method of claim 6 further including the step of treating the refractory anchor with a peroxide to increase the aluminium oxide in the protective layer.

16. The refractory anchor of claim 2, wherein the stainless steel is 253MA grade.

17. The refractory anchor of claim 2, wherein the anchor has a stem having a proximal end securable to a surface within the cement plant, and a distal end which is split into two arms, defining a generally Y-shaped profile.
